(19) United States
(12) Patent Application Publication
(10) Pub. No.: US 2024/0386726 A1
(43) Pub. Date: Nov. 21, 2024

(54) THREE-DIMENSIONAL TARGET DETECTION METHOD AND VEHICLE

(71) Applicant: XIAOMI EV TECHNOLOGY CO., LTD., Beijing (CN)

(72) Inventor: Shaohua WAN, Beijing (CN)

(21) Appl. No.: 18/238,394

(22) Filed: Aug. 25, 2023

(30) Foreign Application Priority Data
May 19, 2023 (CN) 202310565718.4

(51) Int. Cl. G06V 20/58; G06T 7/73; G06V 10/22; G06V 10/24; G06V 10/26; G06V 20/64

(52) U.S. Cl. CPC G06V 20/586; G06T 7/73; G06V 10/225; G06V 10/245; G06V 10/26; G06V 20/64; G06T 2207/30264; G06V 2201/07

(57) ABSTRACT

A three-dimensional target detection method includes: acquiring a surrounding image of a vehicle; inputting the surrounding image of the vehicle into a preset target detection model, and acquiring three-dimensional detection framework information of a target vehicle output by the target detection model; obtaining auxiliary detection information of the target vehicle by performing at least one of a grounding line detection, an in-garage location detection and an occlusion rate detection on the surrounding image of the vehicle; and obtaining corrected three-dimensional detection framework information of the target vehicle by correcting the three-dimensional detection framework information of the target vehicle according to the auxiliary detection information of the target vehicle.

### CROSS-REFERENCE TO RELATED APPLICATION

This application is based on and claims priority to Chinese Patent Application No. 202310565718.4 filed on May 19, 2023, the entire contents of which are incorporated herein by reference for all purposes.

### BACKGROUND

Key parts of present three-dimensional target detection method include inputting a surrounding image of a vehicle into a preset target detection model and acquiring three-dimensional detection framework information of a plurality of target vehicles output by the target detection model. In such methods, the surrounding image of the vehicle is collected by an image sensor on the vehicle, the noise in the surrounding image jitters, and the target detection model is sensitive to the jitter of the noise, which leads to the low accuracy and poor stability of the three-dimensional detection framework information detected by the target detection model.

### SUMMARY

The present disclosure relates to a field of automatic driving and intelligent perception, and in particular to a three-dimensional target detection method and a vehicle.

According to a first aspect of embodiments of the present disclosure, a three-dimensional target detection method is provided, and the method includes: acquiring a surrounding image of a vehicle; inputting the surrounding image of the vehicle into a preset target detection model, and acquiring three-dimensional detection framework information of a target vehicle output by the target detection model; obtaining auxiliary detection information of the target vehicle by performing at least one of a grounding line detection, an in-garage location detection and an occlusion rate detection on the surrounding image of the vehicle; and obtaining corrected three-dimensional detection framework information of the target vehicle by correcting the three-dimensional detection framework information of the target vehicle according to the auxiliary detection information of the target vehicle.

According to a second aspect of embodiments of the present disclosure, a vehicle is further provided, and includes a processor and a memory storing instructions that, when executed by the processor, cause the processor to execute the three-dimensional target detection method of the first aspect.

According to a third aspect of embodiments of the present disclosure, a non-transitory computer-readable storage medium is provided. The storage medium stores machine-readable instructions that, when executed by a processor, cause the processor to: execute the three-dimensional target detection method of the first aspect.

It is to be understood that both the foregoing general description and the following detailed description are illustrative and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and together with the description, serve to explain the principles of the present disclosure, and do not unduly limit the present disclosure.

FIG. 1 is a flowchart of a three-dimensional target detection method according to an embodiment of the present disclosure.

FIG. 2 is a schematic diagram of grounding line information of a surrounding image of a vehicle.

FIG. 3 is a flowchart of a three-dimensional target detection method according to another embodiment of the present disclosure.

FIG. 4 is a schematic diagram of a three-dimensional target detection device according to an embodiment of the present disclosure.

FIG. 5 is a block diagram of a vehicle according to an illustrative embodiment of the present disclosure.

### DETAILED DESCRIPTION

In order to make those ordinary skilled in the art better understand the technical solution of the present disclosure, the technical solution in the embodiments of the present disclosure will be described clearly and completely with reference to the attached drawings.

It should be noted that the terms including “first” and “second” in the description and claims of the present disclosure and the above drawings are used to distinguish similar objects, and are not necessarily used to describe a specific order or sequence. It should be understood that the data so used may be interchanged under appropriate circumstances, so that the embodiments of the present disclosure described herein may be implemented in other orders than those illustrated or described herein. The embodiments described in the following illustrative embodiments do not represent all embodiments consistent with the present disclosure. Rather, they are merely examples of devices and methods consistent with some aspects of the present disclosure as detailed in the appended claims.

At present, a three-dimensional target detection method is mainly to input a surrounding image of a vehicle into a preset target detection model and acquire three-dimensional detection framework information of a plurality of target vehicles output by the target detection model. In the above solution, the surrounding image of the vehicle is collected by an image sensor on the vehicle, the noise in the surrounding image jitters, and the target detection model is sensitive to the jitter of the noise, which leads to the low accuracy and poor stability of the three-dimensional detection framework information detected by the target detection model.

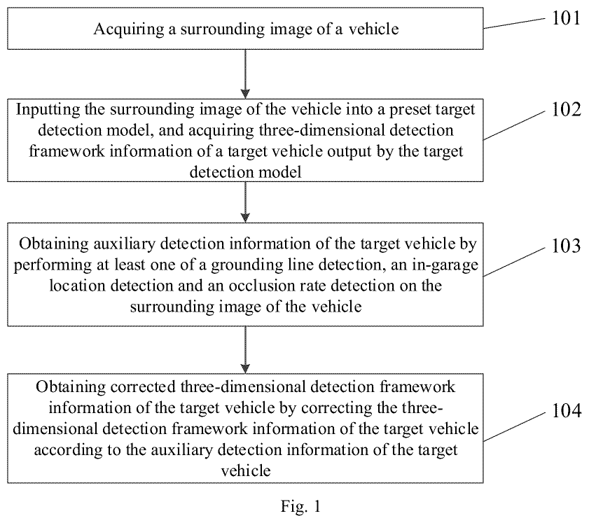

FIG. 1 is a flowchart of a three-dimensional target detection method according to an embodiment of the present disclosure. It should be noted that the three-dimensional target detection method of this embodiment may be applied to a three-dimensional target detection device, which may be configured in electronic equipment of a vehicle or electronic equipment communicating with the vehicle, so that the electronic equipment may perform a three-dimensional target detection function.

The electronic equipment may be any apparatus with computing power, such as an image acquisition apparatus, a Personal Computer (PC), a mobile terminal, a server, etc. The mobile terminal may be, for example, an on-board apparatus, a mobile phone, a tablet computer, a personal digital assistant, a wearable apparatus and other hardware apparatuses with various operating systems, touch screens and/or display screens. In the following embodiments, an example in which the electronic equipment serves as an execution subject is taken for explanations.

As shown in FIG. 1, the method includes the following steps.

At step 101, a surrounding image of a vehicle is acquired.

In the embodiment of the present disclosure, the surrounding image of the vehicle may be a two-dimensional image acquired by an image sensor on the vehicle. The number of the surrounding images of the vehicle may be one or more. For example, if the acquisition region is a small-angle range in front of the vehicle, one image sensor may be used to carry out the image acquisition processing on the front of the vehicle at the current location of the vehicle to obtain one surrounding image of the vehicle. For another example, if the acquisition region is a large-angle range around the vehicle, such as a full-angle range, a plurality of image sensors facing different directions may be used at the current location of the vehicle to carry out the image acquisition processing to obtain a plurality of surrounding images of the vehicle.

At step 102, the surrounding image of the vehicle is input into a preset target detection model, and three-dimensional detection framework information of at least one target vehicle output by the target detection model is acquired.

In the embodiment of the present disclosure, the preset target detection model may be obtained by being trained according to a large number of sample images and the three-dimensional detection framework information of the targets in the sample images.

The three-dimensional detection framework information of the target vehicle may include at least one of detection framework location information, detection framework direction information, detection framework category information and confidence information. When the three-dimensional detection framework information is the three-dimensional detection framework information of the vehicle, the detection framework category information is a category of the vehicle.

The detection framework location information may include length information, width information, height information and three-dimensional coordinate information of a center point of a detection framework. It should be noted that the three-dimensional coordinate information or location information mentioned in the present disclosure refers to the coordinate information or location information in the same three-dimensional coordinate system, and will not be described again below. The three-dimensional coordinate system, such as the world coordinate system and the vehicle body coordinate system, may be set according to actual needs.

In an example, the number of the confidence information may be one, and the confidence information may be the confidence of three-dimensional detection framework information. In another example, the number of the confidence information may be two, one confidence information is the confidence of the detection framework location information and the other confidence information is the confidence of the detection framework category information.

At step 103, at least one of a grounding line detection, an in-garage location detection and an occlusion rate detection is performed on the surrounding image of the vehicle to obtain auxiliary detection information of the at least one target vehicle.

It may be understood that an in-garage location herein refers to a location in a garage, and the vehicle is configured to be parked in such location.

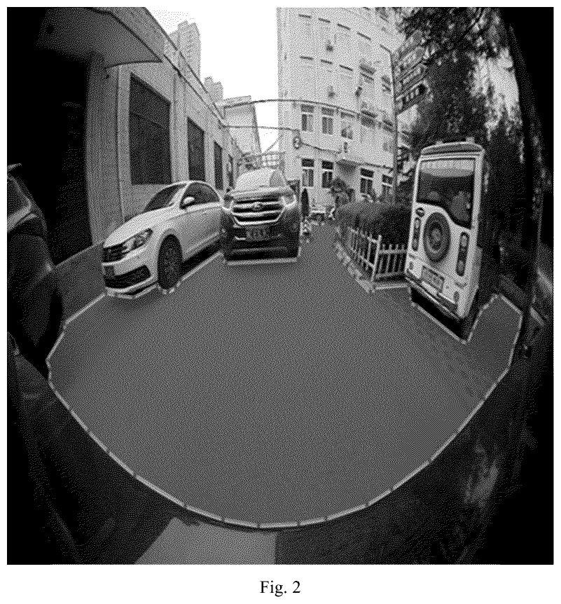

In the embodiment of the present disclosure, the grounding line detection algorithm may be, for example, a free space detection algorithm. Combined with the free space detection algorithm, a plurality of grounding line segments in the surrounding image of the vehicle and a target category corresponding to each grounding line segment may be obtained, that is, the grounding line segment of each target in the surrounding image of the vehicle may be obtained. The targets are, for example, vehicles, columns, traffic cones, curbs, walls, etc. Taking an example in which the target is the vehicle, the grounding line information of the vehicle may include the coordinate information of each point in the grounding line segment of the vehicle. This coordinate information is coordinate information in the three-dimensional coordinate system. A schematic diagram of the grounding line information of the surrounding image of the vehicle can be seen in FIG. 2, in which the grounding line formed by the grounding line segments of a plurality of targets is shown, but the target category corresponding to each grounding line segment is not shown.

In the embodiment of the present disclosure, corner point information of the in-garage location of each vehicle in the surrounding image of the vehicle may be obtained by performing the in-garage location detection on the surrounding image of the vehicle. The corner point information of the in-garage location refers to coordinate information of each corner of the in-garage location where the vehicle is. The coordinate information is coordinate information in the three-dimensional coordinate system.

In the embodiment of the present disclosure, one detection algorithm for the occlusion rate detection may be, for example, determining the grounding line segment of each target in the surrounding image of the vehicle in combination with the free space detection algorithm, and for each target, determining an occlusion rate of the target in combination with a length of the grounding line segment of the target and a total length of a ground projection boundary of the target. For example, for one vehicle, a ratio of the length of the grounding line segment of the vehicle to the total length of the ground projection boundary of the vehicle is taken as the occlusion rate of the vehicle.

In the embodiment of the present disclosure, different detections may be performed on the surrounding image of the vehicle in different scenes to obtain the auxiliary detection information of the target vehicle. When the scene corresponding to the surrounding image of the vehicle is a parking lot scene, at least one of the grounding line detection, the in-garage location detection and the occlusion rate detection may be performed on the surrounding image of the vehicle. When the scene corresponding to the surrounding image of the vehicle is a road driving scene, at least one of the grounding line detection and the occlusion rate detection may be performed on the surrounding image of the vehicle.

The scene corresponding to the surrounding image of the vehicle is the scene where the vehicle acquiring the surrounding image of the vehicle is located.

For specific scenes, different target vehicles have different auxiliary detection information in detection results obtained after detecting the surrounding image of the vehicle. Taking the parking lot scene as an example, for vehicles in a moving state, such as vehicles outside the garage and vehicles in a parking-in or parking-out state, the grounding line information and the occlusion rate information of the vehicles may be detected. For vehicles in a stationary state, for example, vehicles located in the garage, it is possible to detect the in-garage location information and the occlusion rate information of the vehicles. That is to say, for different target vehicles in the same surrounding image of the vehicle, different auxiliary detection information may be detected and obtained.

At step 104, for each target vehicle, the three-dimensional detection framework information of the target vehicle is corrected according to the auxiliary detection information of the target vehicle, to obtain corrected three-dimensional detection framework information of the target vehicle.

In the embodiment of the present disclosure, for the target vehicle, if the auxiliary detection information of the target vehicle includes a variety of information, the three-dimensional detection framework information of the target vehicle may be corrected for each information in turn and in combination with this information, and the corrected three-dimensional detection framework information of the target vehicle may be obtained after the correction is completed in combination with the variety of information.

In the three-dimensional target detection method of the embodiment of the present disclosure, the surrounding image of the vehicle is acquired, the surrounding image of the vehicle is input into the preset target detection model, the three-dimensional detection framework information of at least one target vehicle output by the target detection model is acquired, at least one of the grounding line detection, the in-garage location detection and the occlusion rate detection is performed on the surrounding image of the vehicle to obtain the auxiliary detection information of the at least one target vehicle, and for each target vehicle, the three-dimensional detection framework information of the target vehicle is corrected according to the auxiliary detection information of the target vehicle, to obtain the corrected three-dimensional detection framework information of the target vehicle, so that the three-dimensional detection framework information of the target vehicle may be corrected in combination with the auxiliary detection information of the target vehicle, so as to avoid the influence of the noise jitter on the accuracy of the three-dimensional detection framework information, thus improving the accuracy of the three-dimensional detection framework information and improving the stability of the three-dimensional target detection.

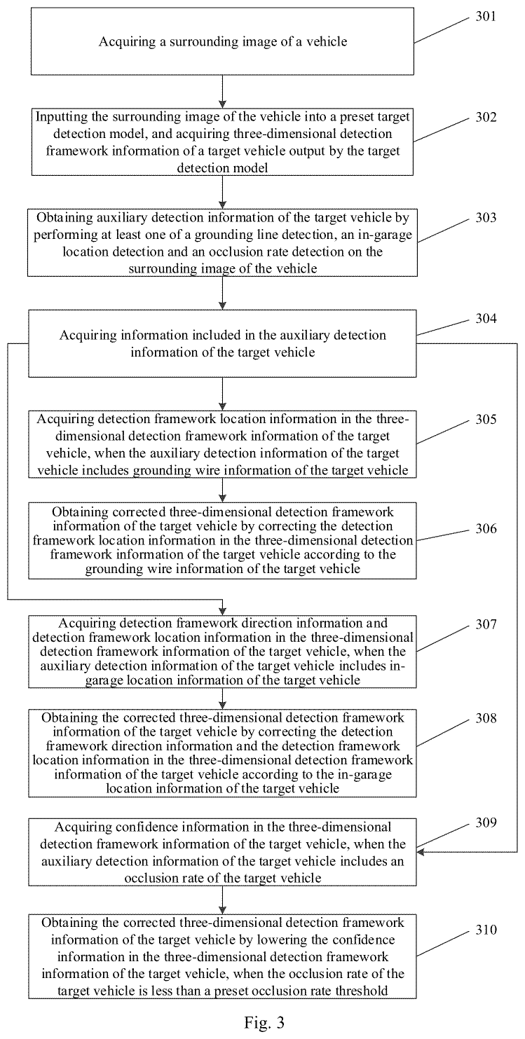

FIG. 3 is a flowchart of a three-dimensional target detection method according to another embodiment of the present disclosure. It should be noted that the three-dimensional target detection method of this embodiment may be applied to a three-dimensional target detection device, which may be configured in electronic equipment of a vehicle or electronic equipment communicated with the vehicle, so that the electronic equipment may perform a three-dimensional target detection function.

The electronic equipment may be any apparatus with computing power, such as an image acquisition apparatus, a Personal Computer (PC), a mobile terminal, a server, etc. The mobile terminal may be, for example, an on-board apparatus, a mobile phone, a tablet computer, a personal digital assistant, a wearable apparatus and other hardware apparatuses with various operating systems, touch screens and/or display screens. In the following embodiments, an example in which the electronic apparatus serves as an execution subject is taken for explanations.

As shown in FIG. 3, the method includes the following steps.

At step 301, a surrounding image of a vehicle is obtained.

At step 302, the surrounding image of the vehicle is input into a preset target detection model, and three-dimensional detection framework information of at least one target vehicle output by the target detection model is acquired.

At step 303, at least one of a grounding line detection, an in-garage location detection and an occlusion rate detection is performed on the surrounding image of the vehicle to obtain auxiliary detection information of the at least one target vehicle.

At step 304, information included in the auxiliary detection information of the target vehicle is acquired for each target vehicle.

At step 305, detection framework location information in the three-dimensional detection framework information of the target vehicle is acquired, if the auxiliary detection information of the target vehicle includes grounding line information of the target vehicle.

At step 306, the detection framework location information in the three-dimensional detection framework information of the target vehicle is corrected according to the grounding line information of the target vehicle to obtain corrected three-dimensional detection framework information of the target vehicle.

In the embodiment of the present disclosure, the process of the electronic equipment executing step 306 may be, for example, as follows: a detection framework region of the target vehicle is determined according to the detection framework location information of the target vehicle; when there is a first grounding point (which is not located in the detection framework region) in the grounding line information, location offset information of the detection framework region is determined according to location information of the first grounding point; the detection framework location information in the three-dimensional detection framework information of the target vehicle is corrected according to the location offset information, to obtain the corrected detection framework location information of the target vehicle.

The detection framework location information may include length information, width information, height information of a detection framework and three-dimensional coordinate information of a center point of the detection framework. The detection framework region determined and obtained according to the detection framework location information may be a three-dimensional region in a three-dimensional coordinate system.

The process of the electronic equipment determining the location offset information of the detection framework region according to the location information of the first grounding point may be, for example, as follows: offset information between a point closest to the first grounding point in the detection framework region and the first grounding point is determined according to the location information of the first grounding point; this offset information is determined as the location offset information of the detection framework region. When a plurality of the first grounding points are provided, the maximum offset information may be selected from a plurality of the determined offset information as the location offset information of the detection framework region.

At step 307, detection framework direction information and the detection framework location information in the three-dimensional detection framework information of the target vehicle are acquired, when the auxiliary detection information of the target vehicle includes in-garage location information of the target vehicle.

At step 308, the detection framework direction information and the detection framework location information in the three-dimensional detection framework information of the target vehicle are corrected according to the in-garage location information of the target vehicle, to obtain the corrected three-dimensional detection framework information of the target vehicle.

In the embodiment of the present disclosure, the process of the electronic equipment executing step 308 may be, for example, as follows: in-garage location direction information is determined according to the in-garage location information of the target vehicle; when the in-garage location direction information is inconsistent with the detection framework direction information, direction offset information between the in-garage location direction information and the detection framework direction information; the detection framework direction information and the detection framework location information in the three-dimensional detection framework information of the target vehicle are corrected according to the direction offset information, to obtain the corrected three-dimensional detection framework information of the target vehicle.

For example, according to the direction offset information, the electronic equipment may correct the detection framework direction information and the detection framework location information in the three-dimensional detection framework information of the target vehicle as follows: the detection framework direction information in the three-dimensional detection framework information of the target vehicle is corrected according to the direction offset information; and the corrected detection framework location information is determined according to the corrected detection framework direction information and the detection framework location information before correction.

At step 309, confidence information in the three-dimensional detection framework information of the target vehicle is acquired, when the auxiliary detection information of the target vehicle includes an occlusion rate of the target vehicle.

At step 310, the confidence information in the three-dimensional detection framework information of the target vehicle is lowered to obtain the corrected three-dimensional detection framework information of the target vehicle, when the occlusion rate of the target vehicle is less than a preset occlusion rate threshold.

In the embodiment of the present disclosure, the auxiliary detection information of the target vehicle may include a variety of detection information. In an example, the auxiliary detection information of the target vehicle may include the grounding line information and the in-garage location information. In another example, the auxiliary detection information of the target vehicle may include the grounding line information and the occlusion rate. In another example, the auxiliary detection information of the target vehicle may include the in-garage location information and the occlusion rate. In another example, the auxiliary detection information of the target vehicle may include the grounding line information, the in-garage location information and the occlusion rate.

When the auxiliary detection information of the target vehicle includes a variety of detection information, the three-dimensional detection framework information of the target vehicle may be corrected in combination with each detection information in turn. For example, when the auxiliary detection information of the target vehicle includes the grounding line information and the occlusion rate, the three-dimensional detection framework information of the target vehicle may be first corrected in combination with the grounding line information, and then the preliminarily corrected three-dimensional detection framework information of the target vehicle is corrected again in combination with the occlusion rate.

For another example, when the auxiliary detection information of the target vehicle includes the in-garage location information and the occlusion rate, the three-dimensional detection framework information of the target vehicle may be first corrected in combination with the in-garage location information, and then the corrected three-dimensional detection framework information of the target vehicle is corrected again in combination with the occlusion rate.

It should be noted that the details of steps 301 to 303 may refer to steps 101 to 103 in the embodiment shown in FIG. 1, and will not be described in detail here.

In the three-dimensional target detection method of the embodiment of the present disclosure, the surrounding image of the vehicle is acquired; the surrounding image of the vehicle is input into the preset target detection model, and the three-dimensional detection framework information of at least one target vehicle output by the target detection model is acquired; at least one of the grounding line detection, the in-garage location detection and the occlusion rate detection is performed on the surrounding image of the vehicle to obtain the auxiliary detection information of the at least one target vehicle; for each target vehicle, the information included in the auxiliary detection information of the target vehicle is acquired; when the auxiliary detection information of the target vehicle includes the grounding line information of the target vehicle, the detection framework location information in the three-dimensional detection framework information of the target vehicle is obtained; according to the grounding line information of the target vehicle, the detection framework location information in the three-dimensional detection framework information of the target vehicle is corrected to obtain the corrected three-dimensional detection framework information of the target vehicle; when the auxiliary detection information of the target vehicle includes the in-garage location information of the target vehicle, the detection framework direction information and the detection framework location information in the three-dimensional detection framework information of the target vehicle are acquired; according to the in-garage location information of the target vehicle, the detection framework direction information and the detection framework location information in the three-dimensional detection framework information of the target vehicle are corrected to obtain the corrected three-dimensional detection framework information of the target vehicle; when the auxiliary detection information of the target vehicle includes the occlusion rate of the target vehicle, the confidence information in the three-dimensional detection framework information of the target vehicle is acquired; when the occlusion rate of the target vehicle is less than the preset occlusion rate threshold, the confidence information in the three-dimensional detection framework information of the target vehicle is lowered to obtain the corrected three-dimensional detection framework information of the target vehicle, so that the three-dimensional detection framework information of the target vehicle may be corrected in combination with the auxiliary detection information of the target vehicle, so as to avoid the influence of the noise jitter on the accuracy of the three-dimensional detection framework information, thus improving the accuracy of the three-dimensional detection framework information, and improving the stability of the three-dimensional target detection.

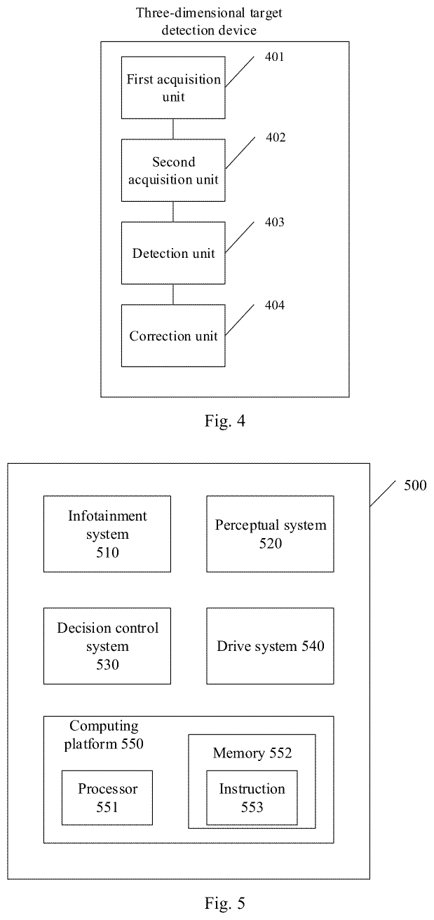

FIG. 4 is a schematic diagram of a three-dimensional target detection device according to an embodiment of the present disclosure.

As shown in FIG. 4, the three-dimensional target detection device may include a first acquisition unit 401, a second acquisition unit 402, a detection unit 403 and a correction unit 404.

The first acquisition unit 401 is configured to acquire a surrounding image of a vehicle.

The second acquisition unit 402 is configured to input the surrounding image of the vehicle into a preset target detection model and acquire three-dimensional detection framework information of at least one target vehicle output by the target detection model.

The detection unit 403 is configured to perform at least one of a grounding line detection, an in-garage location detection and an occlusion rate detection on the surrounding image of the vehicle to obtain auxiliary detection information of the at least one target vehicle.

The correction unit 404 is configured to correct the three-dimensional detection framework information of the target vehicle according to the auxiliary detection information of the target vehicle to obtain corrected three-dimensional detection framework information of the target vehicle, for each target vehicle.

In an embodiment of the present disclosure, the auxiliary detection information of the target vehicle includes grounding line information of the target vehicle. The correction unit 404 is specifically configured to obtain detection framework location information in the three-dimensional detection framework information of the target vehicle, correct the detection framework location information in the three-dimensional detection framework information of the target vehicle according to the grounding line information of the target vehicle, so as to obtain the corrected three-dimensional detection framework information of the target vehicle.

In an embodiment of the present disclosure, the correction unit 404 is further specifically configured to determine a detection framework region of the target vehicle according to the detection framework location information of the target vehicle, determine location offset information of the detection framework region according to location information of the first grounding point when there is a first grounding point (which is not located in the detection framework region) in the grounding line information, and correct the detection framework location information in the three-dimensional detection framework information of the target vehicle according to the location offset information, so as to obtain the corrected detection framework location information of the target vehicle.

In an embodiment of the present disclosure, the auxiliary detection information of the target vehicle includes in-garage location information of the target vehicle. The correction unit 404 is specifically configured to obtain detection framework direction information and detection framework location information in the three-dimensional detection framework information of the target vehicle, correct the detection framework direction information and the detection framework location information in the three-dimensional detection framework information of the target vehicle according to the in-garage location information of the target vehicle, so as to obtain the corrected three-dimensional detection framework information of the target vehicle.

In an embodiment of the present disclosure, the correction unit 404 is further specifically configured to determine in-garage location direction information according to the in-garage location information of the target vehicle, determine direction offset information between the in-garage location direction information and the detection framework direction information when the in-garage location direction information is inconsistent with the detection framework direction information, and correct the detection framework direction information and the detection framework location information in the three-dimensional detection framework information of the target vehicle according to the direction offset information, so as to obtain the corrected three-dimensional detection framework information of the target vehicle.

In an embodiment of the present disclosure, the auxiliary detection information of the target vehicle includes an occlusion rate of the target vehicle. The correction unit 404 is specifically configured to obtain confidence information in the three-dimensional detection framework information of the target vehicle, lower the confidence information in the three-dimensional detection framework information of the target vehicle when the occlusion rate of the target vehicle is less than a preset occlusion rate threshold, so as to obtain the corrected three-dimensional detection framework information of the target vehicle.

In an embodiment of the present disclosure, the scene corresponding to the surrounding image of the vehicle is a parking lot scene. When the target vehicle is in a moving state, the auxiliary detection information of the target vehicle includes at least one of the grounding line information and the occlusion rate. When the target vehicle is in a stationary state, the auxiliary detection information of the target vehicle includes at least one of the in-garage location information and the occlusion rate.

In the three-dimensional target detection device of the embodiment of the present disclosure, the surrounding image of the vehicle is acquired, the surrounding image of the vehicle is input into the preset target detection model, the three-dimensional detection framework information of at least one target vehicle output by the target detection model is acquired, at least one of the grounding line detection, the in-garage location detection and the occlusion rate detection is performed on the surrounding image of the vehicle to obtain the auxiliary detection information of the at least one target vehicle, and for each target vehicle, the three-dimensional detection framework information of the target vehicle is corrected according to the auxiliary detection information of the target vehicle, to obtain the corrected three-dimensional detection framework information of the target vehicle, so that the three-dimensional detection framework information of the target vehicle may be corrected in combination with the auxiliary detection information of the target vehicle, so as to avoid the influence of the noise jitter on the accuracy of the three-dimensional detection framework information, thus improving the accuracy of the three-dimensional detection framework information and improving the stability of the three-dimensional target detection.

According to embodiments of the present disclosure, there is also provided a vehicle including a processor, and a memory for storing instructions executable by the processor. The processor is configured to implement the three-dimensional target detection method as described above.

In order to realize the above embodiments, the present disclosure also provides a storage medium.

When instructions in the storage medium are executed by a processor, the processor is enabled to perform the three-dimensional target detection method as described above.

In order to realize the above embodiments, the present disclosure also provides a computer program product.

When the computer program product is executed by a processor of the electronic equipment, the electronic equipment is enabled to perform the above method.

FIG. 5 is a block diagram of a vehicle 500 according to an illustrative embodiment of the present disclosure. For example, the vehicle 500 may be a hybrid vehicle, a non-hybrid vehicle, an electric vehicle, a fuel cell vehicle or other types of vehicles. The vehicle 500 may be an autonomous vehicle, a semi-autonomous vehicle or a non-autonomous vehicle.

Referring to FIG. 5, the vehicle 500 may include various subsystems, such as an infotainment system 510, a perception system 520, a decision control system 530, a drive system 540, and a computing platform 550. The vehicle 500 may also include more or less subsystems, and each subsystem may include a plurality of components. In addition, the subsystems and the components of the vehicle 500 may be interconnected in a wired or wireless manner.

In some embodiments, the infotainment system 510 may include a communication system, an entertainment system, a navigation system and the like.

The perception system 520 may include several sensors for sensing information of the environment around the vehicle 500. For example, the perception system 520 may include a global positioning system (the global positioning system may be a GPS system, BeiDou Navigation Satellite System or other positioning systems), an inertial measurement unit (IMU), a lidar, a millimeter-wave radar, an ultrasonic radar and a camera.

The decision control system 530 may include a computing system, a vehicle controller, a steering system, an accelerator and a braking system.

The drive system 540 may include components that provide power movements for the vehicle 500. In an embodiment, the drive system 540 may include an engine, an energy source, a transmission system and wheels. The engine may be one or a combination of an internal combustion engine, an electric motor and an air compression engine. The engine may convert the energy provided by the energy source into the mechanical energy.

Some or all functions of the vehicle 500 are controlled by the computing platform 550. The computing platform 550 may include a processor 551 and a memory 552, and the processor 551 may execute instructions 553 stored in the memory 552. Processor 551 may include a single processor or multiple processors.

The processor 551 may be any conventional processor, such as a commercially available CPU. The processor may also include, for example, a Graphic Process Unit (GPU), a Field Programmable Gate Array (FPGA), a System on Chip (SOC), an Application Specific Integrated Circuit (ASIC) or a combination thereof.

The memory 552 may be realized by any type of volatile or nonvolatile memory device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

In addition to the instruction 553, the memory 552 may also store data, such as a road map, route information, a vehicle location, a direction, a speed and so on. The data stored in the memory 552 may be used by the computing platform 550.

In the embodiment of the present disclosure, the processor 551 may execute the instruction 553 to complete all or part of the steps of the three-dimensional target detection method described above.

Furthermore, the word “illustrative” is used herein to mean serving as an example, an instance, and a diagram. Any aspect or design described herein as “illustrative” is not necessarily to be understood as advantageous over other aspects or designs. On the contrary, the use of the word “illustrative” is intended to present concepts in a concrete way. As used herein, the term “or” is intended to mean an inclusive “or” rather than an exclusive “or”. That is, unless otherwise specified or clear from the context, “X is applied to A or B” is intended to mean any one of the natural inclusive arrangements. That is, if X is applied A, X is applied to B, or X is applied to both A and B, then “X is applied to A or B” is satisfied in any of the foregoing examples. In addition, the articles “a” and “an” as used in this application and the appended claims are generally understood to mean “one or more” unless otherwise specified or clearly pointed out from the context.

Likewise, although the present disclosure has been shown and described with respect to one or more implementations, equivalent variations and modifications will occur to those skilled in the art after reading and understanding the specification and drawings. The present disclosure includes all such modifications and variations, and is limited only by the scope of the claims. With particular reference to various functions performed by the above components (e.g., elements, resources, etc.), unless otherwise indicated, the terms used to describe such components are intended to correspond to any component (functionally equivalent) that performs the specific functions of the described components, even if it is not structurally equivalent to the disclosed structure. In addition, although a particular feature of the present disclosure may have been disclosed with respect to only one of several implementations, such feature may be combined with one or more other features of other implementations, as desirable and advantageous for any given or specific application. Furthermore, in terms of “including”, “possessing”, “provided”, “having”, or variations thereof used in the detailed description or claims, such terms are intended to be inclusive in a manner similar to the term “comprising”.

Other embodiments of the present disclosure will easily occur to those skilled in the art after they consider the specification and practicing the invention disclosed herein. This application is intended to cover any variations, uses or adaptations of the present disclosure, which follow the general principles of the present disclosure and include common sense or common technical means in the art that are not disclosed in the present disclosure. The description and embodiment are to be regarded as illustrative only, while the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the appended claims.

What is claimed is:

1. A three-dimensional target detection method, comprising:
acquiring a surrounding image of a vehicle;
inputting the surrounding image of the vehicle into a preset target detection model, and acquiring three-dimensional detection framework information of a target vehicle output by the target detection model;
obtaining auxiliary detection information of the target vehicle by performing at least one of a grounding line detection, an in-garage location detection and an occlusion rate detection on the surrounding image of the vehicle; and
obtaining corrected three-dimensional detection framework information of the target vehicle by correcting the three-dimensional detection framework information of the target vehicle according to the auxiliary detection information of the target vehicle.

2. The method according to claim 1, wherein the auxiliary detection information of the target vehicle comprises grounding line information of the target vehicle, and the obtaining the corrected three-dimensional detection framework information comprises:
acquiring detection framework location information in the three-dimensional detection framework information of the target vehicle; and
obtaining the corrected three-dimensional detection framework information of the target vehicle by correcting the detection framework location information in the three-dimensional detection framework information of the target vehicle according to the grounding line information of the target vehicle.

3. The method according to claim 2, wherein the obtaining the corrected three-dimensional detection framework information comprises:
determining a detection framework region of the target vehicle according to the detection framework location information of the target vehicle;
in response to determining that there is a first grounding point in the grounding line information, wherein the first grounding point is not located in the detection framework region, determining location offset information of the detection framework region according to location information of the first grounding point; and
obtaining the corrected detection framework location information of the target vehicle by correcting the detection framework location information in the three-dimensional detection framework information of the target vehicle according to the location offset information.

4. The method according to claim 1, wherein the auxiliary detection information of the target vehicle comprises in-garage location information of the target vehicle, and the obtaining the corrected three-dimensional detection framework information comprises:
acquiring detection framework direction information and detection framework location information in the three-dimensional detection framework information of the target vehicle; and
obtaining the corrected three-dimensional detection framework information of the target vehicle by correcting the detection framework direction information and the detection framework location information in the three-dimensional detection framework information of the target vehicle according to the in-garage location information of the target vehicle.

5. The method according to claim 4, wherein the obtaining the corrected three-dimensional detection framework information of the target vehicle by correcting the detection framework direction information and the detection framework location information in the three-dimensional detection framework information of the target vehicle according to the in-garage location information of the target vehicle comprises:
determining in-garage location direction information according to the in-garage location information of the target vehicle;
determining direction offset information between the in-garage location direction information and the detection framework direction information in response to determining that the in-garage location direction information is inconsistent with the detection framework direction information; and
obtaining the corrected three-dimensional detection framework information of the target vehicle by correcting the detection framework direction information and the detection framework location information in the three-dimensional detection framework information of the target vehicle according to the direction offset information.

6. The method according to claim 1, wherein the auxiliary detection information of the target vehicle comprises an occlusion rate of the target vehicle, and the obtaining the corrected three-dimensional detection framework information comprises:
acquiring confidence information in the three-dimensional detection framework information of the target vehicle; and
obtaining the corrected three-dimensional detection framework information of the target vehicle by lowering the confidence information in the three-dimensional detection framework information of the target vehicle in response to determining that the occlusion rate of the target vehicle is less than a preset occlusion rate threshold.

7. The method according to claim 1, wherein a scene corresponding to the surrounding image of the vehicle is a parking lot scene;
in response to determining that the target vehicle is in a moving state, the auxiliary detection information of the target vehicle comprises at least one of grounding line information and an occlusion rate; and
in response to determining that the target vehicle is in a stationary state, the auxiliary detection information of the target vehicle comprises at least one of in-garage location information and an occlusion rate.

8. A vehicle, comprising:
a processor; and
a memory storing instructions that, when executed by the processor,
cause the processor to:
acquire a surrounding image of a vehicle;
input the surrounding image of the vehicle into a preset target detection model, and acquire three-dimensional detection framework information of a target vehicle output by the target detection model;
obtain auxiliary detection information of the target vehicle by performing at least one of a grounding line detection, an in-garage location detection and an occlusion rate detection on the surrounding image of the vehicle; and
obtain corrected three-dimensional detection framework information of the target vehicle by correcting the three-dimensional detection framework information of the target vehicle according to the auxiliary detection information of the target vehicle.

9. The vehicle according to claim 8, wherein the auxiliary detection information of the target vehicle comprises grounding line information of the target vehicle, and the memory further storing instructions that, when executed by the processor, cause the processor to:
acquire detection framework location information in the three-dimensional detection framework information of the target vehicle; and
obtain the corrected three-dimensional detection framework information of the target vehicle by correcting the detection framework location information in the three-dimensional detection framework information of the target vehicle according to the grounding line information of the target vehicle.

10. The vehicle according to claim 9, the memory further storing instructions that, when executed by the processor, cause the processor to:
determine a detection framework region of the target vehicle according to the detection framework location information of the target vehicle;
in response to determining that there is a first grounding point in the grounding line information, wherein the first grounding point is not located in the detection framework region, determine location offset information of the detection framework region according to location information of the first grounding point; and
obtain the corrected detection framework location information of the target vehicle by correcting the detection framework location information in the three-dimensional detection framework information of the target vehicle according to the location offset information.

11. The vehicle according to claim 8, wherein the auxiliary detection information of the target vehicle comprises in-garage location information of the target vehicle, and the memory further storing instructions that, when executed by the processor, cause the processor to:
acquire detection framework direction information and detection framework location information in the three-dimensional detection framework information of the target vehicle; and
obtain the corrected three-dimensional detection framework information of the target vehicle by correcting the detection framework direction information and the detection framework location information in the three-dimensional detection framework information of the target vehicle according to the in-garage location information of the target vehicle.

12. The vehicle according to claim 11, the memory further storing instructions that, when executed by the processor, cause the processor to:
determine in-garage location direction information according to the in-garage location information of the target vehicle;
determine direction offset information between the in-garage location direction information and the detection framework direction information in response to determining that the in-garage location direction information is inconsistent with the detection framework direction information; and
obtain the corrected three-dimensional detection framework information of the target vehicle by correcting the detection framework direction information and the detection framework location information in the three-dimensional detection framework information of the target vehicle according to the direction offset information.

13. The vehicle according to claim 8, wherein the auxiliary detection information of the target vehicle comprises an occlusion rate of the target vehicle, the memory further storing instructions that, when executed by the processor, cause the processor to:
acquire confidence information in the three-dimensional detection framework information of the target vehicle; and
obtain the corrected three-dimensional detection framework information of the target vehicle by lowering the confidence information in the three-dimensional detection framework information of the target vehicle in response to determining that the occlusion rate of the target vehicle is less than a preset occlusion rate threshold.

14. The vehicle according to claim 8, wherein a scene corresponding to the surrounding image of the vehicle is a parking lot scene;
in response to determining that the target vehicle is in a moving state, the auxiliary detection information of the target vehicle comprises at least one of grounding line information and an occlusion rate; and
in response to determining that the target vehicle is in a stationary state, the auxiliary detection information of the target vehicle comprises at least one of in-garage location information and an occlusion rate.

15. A non-transitory computer-readable storage medium storing instructions that, when executed by a processor, cause the processor to:
acquire a surrounding image of a vehicle;
input the surrounding image of the vehicle into a preset target detection model, and acquire three-dimensional detection framework information of a target vehicle output by the target detection model;
obtain auxiliary detection information of the target vehicle by performing at least one of a grounding line detection, an in-garage location detection and an occlusion rate detection on the surrounding image of the vehicle; and
obtain corrected three-dimensional detection framework information of the target vehicle by correcting the three-dimensional detection framework information of the target vehicle according to the auxiliary detection information of the target vehicle.
